(19) United States
(12) Patent Application Publication
(10) Pub. No.: US 2025/0156838 A1
(43) Pub. Date: May 15, 2025

(54) DYNAMIC ELECTRONIC IDENTIFICATION ASSOCIATED WITH ELECTRONIC CARD

(71) Applicant: Capital One Services, LLC, McLean, VA (US)

(72) Inventors: Lea CODY, Washington DC, DC (US); Alex JIANG, Arlington, VA (US); Jianna GEORGE, Tysons, VA (US); Alexandra ROSSANO, Scarsdale, NY (US); Ryan PLATT, McLean, VA (US)

(21) Appl. No.: 18/510,061

(22) Filed: Nov. 15, 2023

(51) Int. Cl. G06Q 20/32; G06Q 20/36; G06Q 20/40; G06Q 30/0601; G06Q 50/26

(52) U.S. Cl. CPC G06Q 20/3265; G06Q 50/265; G06Q 20/363; G06Q 20/4014; G06Q 30/0607

(57) ABSTRACT

In some implementations, a device may receive, from a mobile device, a request to associate a dynamic electronic identification of a user with an electronic card of the user. The device may validate, based at least in part on receiving the request to associate the dynamic electronic identification with the electronic card, the dynamic electronic identification. The device may configure, at the mobile device, based at least in part on validating the dynamic electronic identification, an association of the dynamic electronic identification with the electronic card. The device may receive, based at least in part on an exchange associated with the electronic card, a request to validate information associated with the dynamic electronic identification. The device may validate the information associated with the dynamic electronic identification.

### BACKGROUND

A mobile driver's license (mDL) is an electronic form of identification that is stored on a user device (e.g., a smartphone, a smart watch, or another suitable device) and usable in place of a traditional (e.g., physical) identity document (e.g., a physical driver's license or non-driver identification card). In general, an mDL may be issued by a trusted identity provider and/or identity validator, such as a government agency, a bank, and/or a mobile network operator. An mDL can provide a secure, convenient, and easily accessible form of identification that can be used for various purposes, such as driving, age verification, or personal identification, among other examples. An mDL typically includes the same or similar information that would be found on a traditional identity document, such as a person's name, address, date of birth, photograph, and driver's license number or identification number.

### SUMMARY

Some implementations described herein relate to a system for dynamic electronic identification. The system may include one or more memories and one or more processors communicatively coupled to the one or more memories. The one or more processors may be configured to receive, from a mobile device, a request to associate a dynamic electronic identification of a user with an electronic card of the user. The one or more processors may be configured to validate, based at least in part on receiving the request to associate the dynamic electronic identification with the electronic card, the dynamic electronic identification. The one or more processors may be configured to configure, at the mobile device, based at least in part on validating the dynamic electronic identification, an association of the dynamic electronic identification with the electronic card. The one or more processors may be configured to receive, based at least in part on an exchange associated with the electronic card, a request to validate information associated with the dynamic electronic identification. The one or more processors may be configured to validate the information associated with the dynamic electronic identification.

Some implementations described herein relate to a method for dynamic electronic identification. The method may include receiving, by a device, from a mobile device, a request to associate a dynamic electronic identification of a user with an electronic card of the user. The method may include validating, by the device, based at least in part on receiving the request to associate the dynamic electronic identification with the electronic card, the dynamic electronic identification. The method may include configuring, by the device, at the mobile device, based at least in part on validating the dynamic electronic identification, an association of the dynamic electronic identification with the electronic card.

Some implementations described herein relate to a non-transitory computer-readable medium that stores a set of instructions. The set of instructions, when executed by one or more processors of a system for dynamic electronic identification, may cause the system for dynamic electronic identification to receive, based at least in part on an exchange associated with an electronic card of a user, a request to validate information associated with a dynamic electronic identification associated with the electronic card of the user. The set of instructions, when executed by one or more processors of the system for dynamic electronic identification, may cause the system for dynamic electronic identification to validate the information associated with the dynamic electronic identification.

### BRIEF DESCRIPTION OF THE DRAWINGS

FIGS. 1A-1B are diagrams of an example associated with dynamic electronic identification associated with an electronic card, in accordance with some embodiments of the present disclosure.

FIG. 2 is a diagram of an example associated with an onboarding process for associating a dynamic electronic identification with an electronic card, in accordance with some embodiments of the present disclosure.

FIG. 3 is a diagram of an example associated with using a dynamic electronic identification associated with an electronic card, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with a dynamic electronic identification associated with an electronic card, in accordance with some embodiments of the present disclosure.

FIG. 6 is a flowchart of an example process associated with a dynamic electronic identification associated with an electronic card, in accordance with some embodiments of the present disclosure.

### DETAILED DESCRIPTION

The following detailed description of example implementations refers to the accompanying drawings. The same reference numbers in different drawings may identify the same or similar elements.

An electronic card (e.g., an electronic credit card) may enable a user to initiate transactions (e.g., electronic purchases), redeem rewards (e.g., electronic tickets for live events), or the like. However, such electronic cards are not associated with trusted identification verification mechanisms. For example, when making an age-restricted purchase (e.g., a purchase of alcohol), the user may be required to present both payment information, such as credit card information, and separate user identification information (e.g., age verification information, such as a driver's license). For example, after a merchant verifies the user's age based on a mobile identifier (e.g., an mDL), the user may separately pay using a digital wallet application. Similarly, when using an electronic ticket associated with the electronic card (e.g., an electronic ticket redeemed via a credit card rewards program), the user may be required to present both the electronic ticket and separate user identification information, such as a driver's license. The electronic card being separate (e.g., independent) from the user identification information increases security risks (e.g., cybersecurity risks) associated with the electronic card. For example, without trusted user identification information associated with the electronic card, a bad actor may misappropriate and/or exploit the electronic card. Furthermore, the electronic card being separate from the user identification information may require the user to share personal information (e.g., driver's license) with a merchant, which can further increase security risks. Moreover, requiring the user to individually provide separate user identification information and payment information can be cumbersome.

Some implementations described herein enable an electronic card to be associated with a trusted, dynamic electronic identification, such as an mDL. In some examples, the dynamic electronic identification may be managed by a trusted entity (e.g., a government responsible for issuing an mDL, a trusted third-party management entity, or the like). During an onboarding (e.g., setup) process, a dynamic electronic identification association platform may associate an electronic card of the user with the dynamic electronic identification of the user (e.g., a user mobile identification, such as an mDL). For example, the dynamic electronic identification association platform may configure a mobile device of the user to store the dynamic electronic identification such that the dynamic electronic identification is accessible via a digital application (e.g., a third-party digital wallet pass) that also enables access to one or more electronic cards (e.g., one or more credit cards) associated with the electronic card. After onboarding, the dynamic electronic identification association platform may facilitate exchanges (e.g., an electronic purchase, event access via an electronic ticket, or the like) by validating the information associated with the dynamic electronic identification. In some examples, a user may share (e.g., tap) a third-party mobile pass, which may contain both a valid mDL and payment card, with a merchant at the time of payment to validate identification and/or age, and submit payment, in one step. For example, the third-party pass may contain all payment cards associated with a third party (e.g., a bank) and may be shared (e.g., tapped) at transaction terminals (e.g., contactless terminals) to submit payment and verify identity in one step.

As a result, associating the trusted, dynamic electronic identification with the electronic card may improve security (e.g., cybersecurity) associated with the electronic card. For example, the dynamic electronic identification platform may, for a given exchange (e.g., electronic transaction) involving the electronic card, validate information associated with the dynamic electronic identification, thereby helping to protect the electronic card. For example, the dynamic electronic identification association platform may validate a user identity and/or information regarding the user, using the dynamic electronic identification, to ensure that an authenticated user is completing a purchase (e.g., an age-restricted purchase), accessing an event with an electronic ticket, or the like. Furthermore, because the dynamic electronic identification association platform may automatically validate the information associated with the dynamic electronic identification, the user may not need to share personal information (e.g., a driver's license) with an entity (e.g., a merchant). For example, the dynamic electronic identification association platform may confirm, to a merchant, whether an age of the user has been validated without sharing the actual age (or any other identifying information of the user) with the merchant. The dynamic electronic identification, being dynamic, may be updated at any suitable time such that the trusted verification information remains consistent and up-to-date, thereby helping to maintain the security of the electronic card. In some examples, associating the dynamic electronic identification with the electronic card may enable the user to provide user identification information and payment information in an integrated manner (e.g., via a single operation, such as a single tap of the mobile device), thereby relieving a burden on the user.

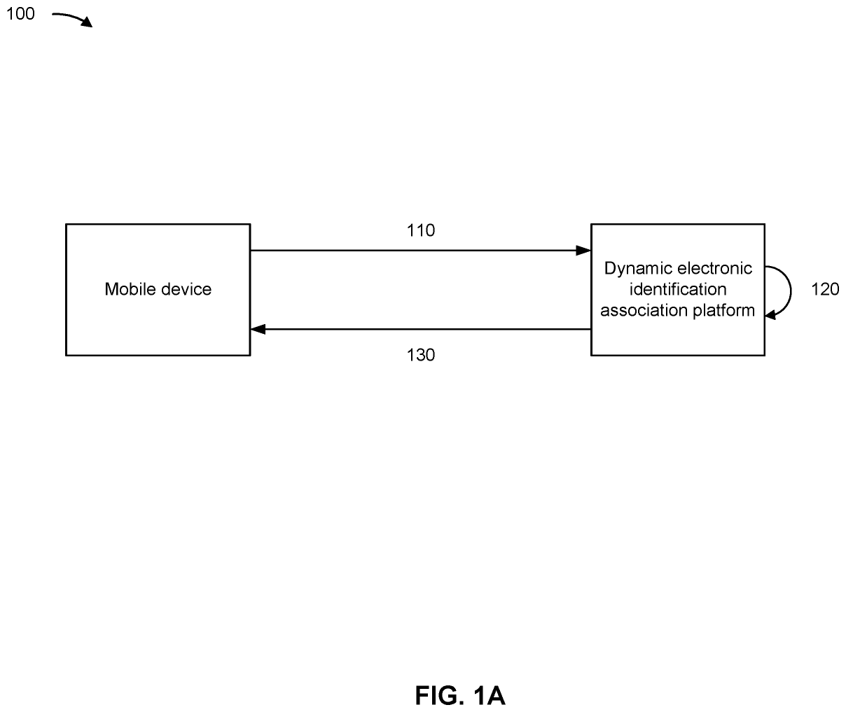

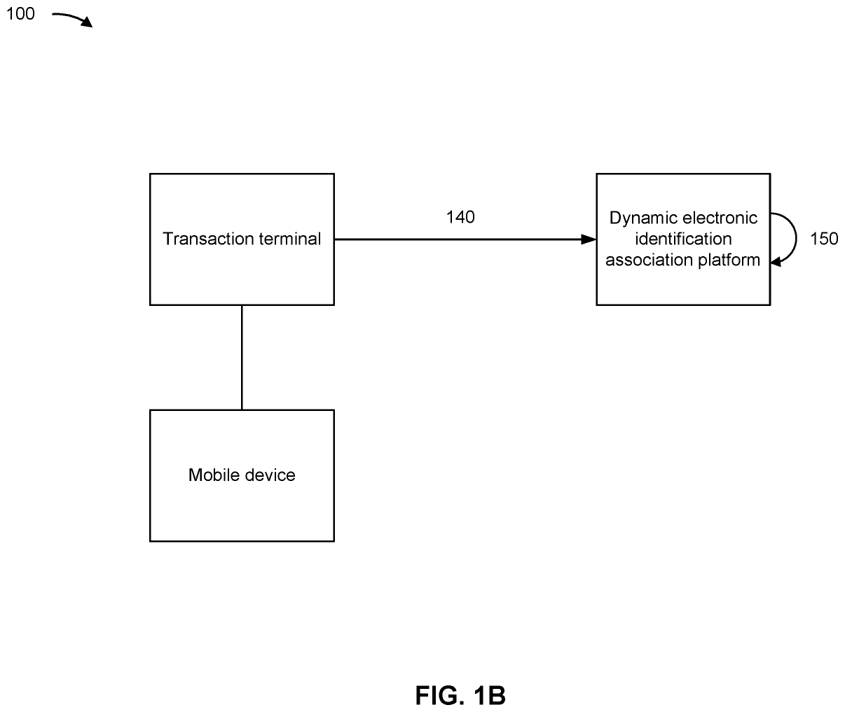

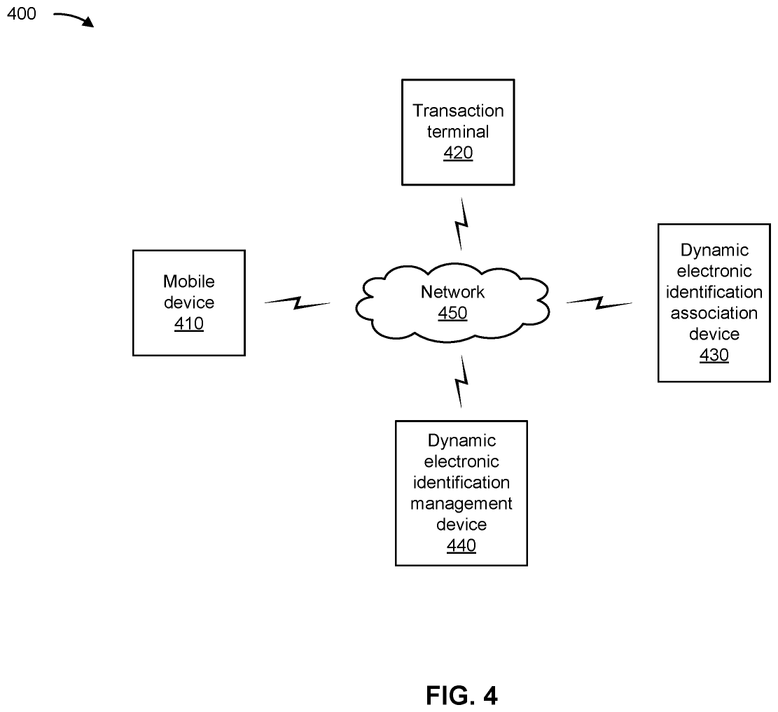

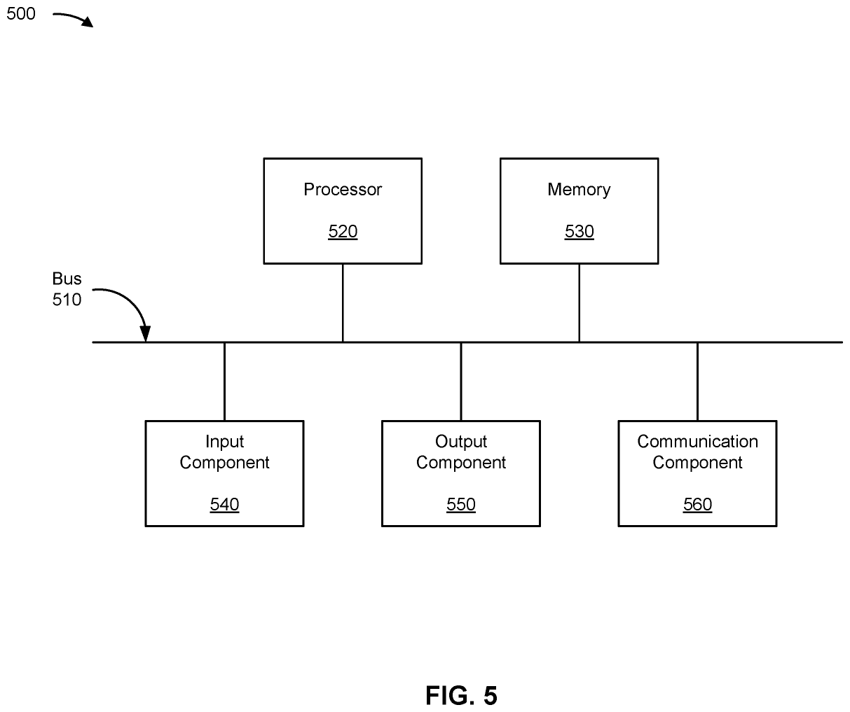

FIGS. 1A-1B are diagrams of an example 100 associated with dynamic electronic identification associated with an electronic card. FIG. 1A relates to an onboarding process, and FIG. 1B relates to use of the dynamic electronic identification associated with the electronic card. As shown in FIGS. 1A-1B, example 100 includes a mobile device, a dynamic electronic identification association platform, a dynamic electronic identification server, and a transaction terminal. These devices are described in more detail in connection with FIGS. 4 and 5.

With reference to FIG. 1A, as shown by reference number 110, the dynamic electronic identification association platform may receive a request to associate a dynamic electronic identification (e.g., an mDL) of a user with an electronic card (e.g., an electronic payment card, such as a credit card) of the user. For example, the dynamic electronic identification association platform may receive the request from a mobile device associated with (e.g., operable by) a user.

In some aspects, the electronic card and the dynamic electronic identification may be associated with a mobile application of the mobile device. For example, the mobile application may be a digital wallet application that stores, links to, or otherwise enables access to the electronic card. The request to associate the dynamic electronic identification with the electronic card may include a request to add the dynamic electronic identification to the digital wallet application.

In some aspects, the dynamic electronic identification may be configured for dynamic updates. For example, the dynamic electronic identification may be dynamically updated with changes to identification information. For example, the dynamic electronic identification may be dynamically updated with changes to an updated address of the user, an updated name of the user, updated physical features of the user, or the like.

As shown by reference number 120, the dynamic electronic identification association platform may validate, based at least in part on receiving the request to associate the dynamic electronic identification with the electronic card, the dynamic electronic identification. For example, the dynamic electronic identification association platform may verify that the dynamic electronic identification is legitimate or valid, that the dynamic electronic identification is associated with the mobile device and/or a user of the electronic card (e.g., based on an age or address verification), or the like.

In some aspects, the dynamic electronic identification association platform may validate the dynamic electronic identification by providing, to a dynamic electronic identification management device, a request to validate the dynamic electronic identification, and receiving, from the dynamic electronic identification management device, a validation of the dynamic electronic identification. For example, the dynamic electronic identification management device may be a trusted entity. For example, the trusted entity may be a government server (e.g., a server managed by a government responsible for issuing the dynamic electronic identification), a third-party server (e.g., a server managed by a trusted third party that is responsible for verifying the dynamic electronic identification), or the like.

As shown by reference number 130, the dynamic electronic identification association platform may configure, at the mobile device, based at least in part on validating the dynamic electronic identification, an association of the dynamic electronic identification with the electronic card. For example, the dynamic electronic identification association platform may transmit an indication, to the mobile device, to store, link to, or otherwise enable the dynamic electronic identification via the mobile application. For example, the mobile device may store the dynamic electronic identification, with the electronic card, in the digital wallet application.

With reference to FIG. 1B, as shown by reference number 140, the dynamic electronic identification association platform may receive, based at least in part on an exchange associated with the electronic card, a request to validate information associated with the dynamic electronic identification. As shown, the dynamic electronic identification association platform may receive the request from a transaction terminal that facilitates the exchange.

The exchange may be any suitable transaction, purchase, or the like. In some aspects, the exchange is an age-restricted exchange (e.g., purchase of alcohol), and the information associated with the dynamic electronic identification includes an age of the user. In some aspects, the exchange is associated with an event, and the information associated with the dynamic electronic identification is associated with user access to the event. For example, the user may use a ticket (e.g., obtained via a rewards program associated with the electronic card, a prior purchase using the electronic card, or the like) to access the event. In some examples, the ticket may be an electronic ticket, which may be stored in the digital wallet application.

As shown by reference number 150, the dynamic electronic identification association platform may validate the information associated with the dynamic electronic identification. In some examples (e.g., in case the exchange is an age-restricted exchange), the dynamic electronic identification association platform may, using the dynamic electronic identification, validate the age of the user. In some examples (e.g., in case the exchange is associated with an event), the dynamic electronic identification association platform may, using the dynamic electronic identification, validate the identity of the user (e.g., a name of the user). Additionally, or alternatively, the dynamic electronic identification association platform may validate an address or any other suitable information associated with the user.

In some aspects, the dynamic electronic identification association platform may validate the information associated with the dynamic electronic identification by providing, to the dynamic electronic identification management device, a request to validate the information associated with the dynamic electronic identification, and receiving, from the dynamic electronic identification management device, a validation of the information associated with the dynamic electronic identification. For example, the dynamic electronic identification association platform may transmit a request to validate user age, identity, or the like, and/or receive the validation of the user age, identity, or the like.

In some aspects (e.g., in case the exchange is a purchase), the dynamic electronic identification association platform may process, based at least in part on validating the information associated with the dynamic electronic identification, the exchange. For example, upon validating the age of the user, the dynamic electronic identification association platform may process an age-restricted exchange (e.g., the dynamic electronic identification association platform may process a purchase of alcohol).

In some aspects, the dynamic electronic identification association platform may provide an indication that the exchange has been processed. For example, the dynamic electronic identification association platform may transmit the indication to the transaction terminal.

Configuring the association of the dynamic electronic identification with the electronic card may improve security (e.g., cybersecurity) of the electronic card. For example, the dynamic electronic identification may be a trusted form of identification that can, once associated with the electronic card, be used to validate an exchange associated with the electronic card. Validating the information associated with the dynamic electronic identification may protect the electronic card from misuse and allow the user to avoid sharing personal information with a merchant.

The dynamic electronic identification being configured for dynamic updates may help to maintain the security of the electronic card. For example, if a user address or other user information changes, then the dynamic electronic identification can be dynamically updated, thereby helping to ensure that information used for verification remains up-to-date.

Validating the dynamic electronic identification and/or the information associated with the dynamic electronic identification using the dynamic electronic identification management device may further improve security. For example, the dynamic electronic identification management device may be trusted to perform the validation(s).

As indicated above, FIGS. 1A-1B are provided as an example. Other examples may differ from what is described with regard to FIGS. 1A-1B.

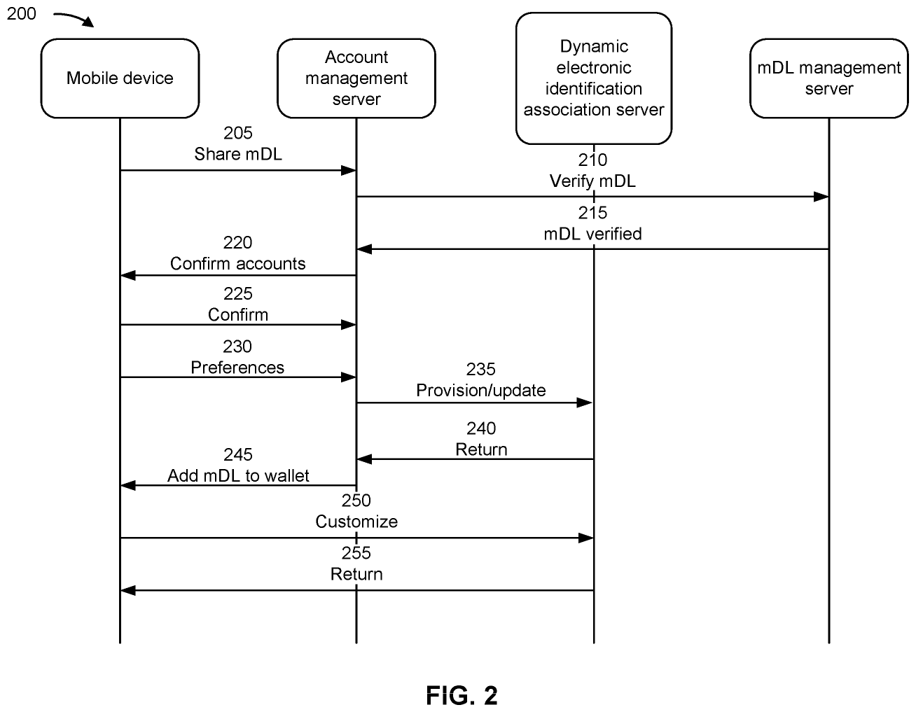

FIG. 2 is a diagram of an example 200 associated with an onboarding process for associating a dynamic electronic identification with an electronic card. Example 200 includes a mobile device, an account management server (e.g., a server configured to manage an account associated with the electronic card), a dynamic electronic identification server, and an mDL management server (e.g., a dynamic electronic identification management device). The account management server and/or the dynamic electronic identification association server may be included in the dynamic electronic identification association platform shown in FIGS. 1A and 1B.

As shown by reference number 205, the account management server may receive, from a mobile device, a request (“share mDL”) to associate an mDL of a user with an electronic card of the user. As shown by reference number 210, the account management server may provide, to the dynamic electronic identification management device, a request to validate (e.g., verify) the mDL. As shown by reference number 215, the account management server may receive, from the dynamic electronic identification management device, a validation of the mDL (e.g., an indication that the mDL has been verified).

As shown by reference number 220, the account management server may transmit, to the mobile device, a request to confirm one or more accounts associated with one or more electronic cards (e.g., a request to confirm that the account(s) are to be associated with the mDL). The account management server may transmit the request based on the mDL being validated (e.g., based on the mDL being real). As shown by reference number 225, the account management server may receive, from the mobile device, a confirmation (e.g., a user confirmation to associate the account(s) with the mDL).

As shown by reference number 230, the account management server may receive, from the mobile device, an indication of one or more user preferences. As shown by reference number 235, the account management server may provide, and the dynamic electronic identification association server may receive, a provision and/or update indication. For example, the provision and/or update indication may indicate that the mDL has been (or is to be) associated with the account(s). As shown by reference number 240, the dynamic electronic identification association server may provide, and the account management server may receive, a return indication (e.g., confirming that the dynamic electronic identification association server has been provisioned or updated).

As shown by reference number 245, the account management server may configure, at the mobile device, an association of the mDL with the electronic card. For example, the account management server may transmit an indication to add the mDL to a digital wallet application that contains the electronic card. As shown by reference number 250, the dynamic electronic identification association server may receive, from the mobile device, one or more user customizations. As shown by reference number 255, the dynamic electronic identification association server may provide, to the mobile device, a return indication (e.g., a confirmation that the user customizations have been implemented).

As indicated above, FIG. 2 is provided as an example. Other examples may differ from what is described with regard to FIG. 2.

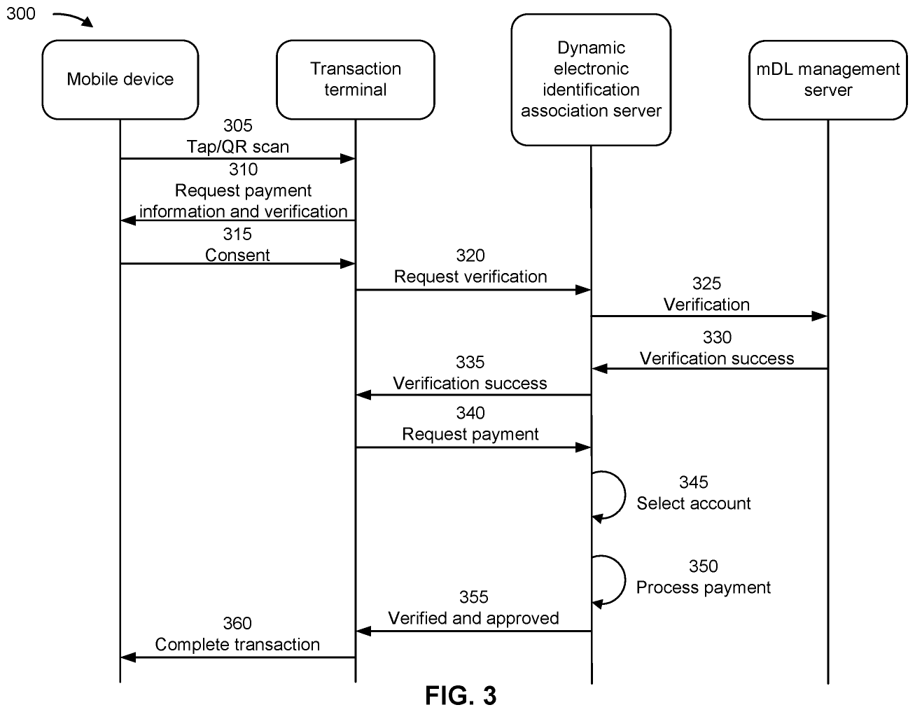

FIG. 3 is a diagram of an example 300 associated with using a dynamic electronic identification associated with an electronic card. For instance, example 300 may occur after example 200 (FIG. 2). Example 300 includes a mobile device, a transaction terminal, a dynamic electronic identification server, and an mDL management server (e.g., a dynamic electronic identification management device).

As shown by reference number 305, a user (e.g., a customer) may initiate an exchange (e.g., an age-restricted purchase) associated with the electronic card by tapping the mobile device on, or scanning a QR code associated with, a transaction terminal. For example, at the time of payment, the user may tap a mobile pass associated with the associated dynamic electronic identification or share the mobile pass via the QR code. For example, the user may tap the mobile pass or scan the QR code if the user is initiating the exchange in person. If the user is online, the user may share the mobile pass through a digital payment system.

As shown by reference number 310, the transaction terminal may request payment information and verification from the mobile device (e.g., the digital wallet application). As shown by reference number 315, the mobile device may provide an indication of user consent to the transaction terminal (e.g., the user may consent to providing the payment information and verification).

As shown by reference number 320, the dynamic electronic identification association server may receive, from the transaction terminal, a request, based at least in part on the exchange, to validate information associated with the dynamic electronic identification. As shown by reference number 325, the dynamic electronic identification association server may provide, to the mDL management server, a request to validate the information associated with the mDL. For example, the dynamic electronic identification association server may provide a request to verify whether the account has an attached (e.g., linked) registered mDL. Thus, a merchant associated with the transaction terminal may request the verification from the mDL management server via the dynamic electronic identification association server.

As shown by reference number 330, the dynamic electronic identification association server may receive, from the mDL management server, a validation of the information associated with the mDL. In some examples, the mDL management server may validate (e.g., verify) the association (e.g., “true link”) with the mDL (e.g., the user identity). As shown by reference number 335, the dynamic electronic identification association server may provide, to the transaction terminal, an indication that the validation (e.g., verification) was successful. Thus, the mDL management server may transmit a success indication to the merchant via the dynamic electronic identification association server.

As shown by reference number 340, the dynamic electronic identification association server may receive, from the transaction terminal, a request for the payment. For example, the dynamic electronic identification association server may receive the request for the payment from the merchant. As shown by reference number 345, the dynamic electronic identification association server may select an account (e.g., the account associated with the electronic card).

As shown by reference number 350, the dynamic electronic identification association server may process the exchange (e.g., the dynamic electronic identification association server may process the payment to approve the transaction). As shown by reference number 355, the dynamic electronic identification association server may provide, to the transaction terminal, an indication that the exchange has been processed. As shown by reference number 360, the transaction terminal may provide, to the mobile device, an indication that the exchange (e.g., transaction) is complete.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a mobile device 410, a transaction terminal 420, a dynamic electronic identification association device 430, a dynamic electronic identification management device 440, and a network 450. Devices of environment 400 may interconnect via wired connections, wireless connections, or a combination of wired and wireless connections.

The mobile device 410 may be a smartphone, a smart watch, or another suitable device. In some implementations, the mobile device 410 may store at least one electronic card. For example, the mobile device 410 may store account information associated with the electronic card, which may be used in connection with an electronic transaction. The account information may include, for example, an account identifier that identifies an account (e.g., a bank account or a credit account) associated with the electronic card (e.g., an account number, a card number, a bank routing number, and/or a bank identifier), a cardholder identifier (e.g., identifying a name of a person, business, or entity associated with the account, expiration information (e.g., identifying an expiration month and/or an expiration year associated with the electronic card), or the like. The mobile device 410 may execute an electronic payment using an electronic card via QR codes, radio frequency communication (e.g., near-field communication (NFC)), magnetic secure transmission (MST), or the like.

The transaction terminal 420 may include one or more devices capable of facilitating an electronic transaction. For example, the transaction terminal 420 may include a point-of-sale (PoS) terminal, a payment terminal (e.g., a contactless payment terminal), or the like. The transaction terminal 420 may include one or more input components and/or one or more output components to facilitate obtaining data (e.g., account information) from a mobile device (e.g., a mobile device executing a payment application) and/or to facilitate interaction with and/or authorization from an owner or accountholder of the transaction device. Example input components of the transaction terminal 420 include a QR code, an RF signal reader (e.g., an NFC reader), a magnetic stripe reader, or the like. Example output devices of the transaction terminal 420 include a display and/or a speaker.

The dynamic electronic identification association device 430 may include one or more devices capable of receiving, generating, storing, processing, providing, and/or routing information associated with associating a dynamic electronic identification associated with an electronic card, as described elsewhere herein. For example, the dynamic electronic identification association device 430 may include the dynamic electronic identification association platform shown in FIGS. 1A and 1B. The dynamic electronic identification association device 430 may include a communication device and/or a computing device. For example, the dynamic electronic identification association device 430 may include a server, such as an application server, a client server, a web server, a database server, a host server, a proxy server, a virtual server (e.g., executing on computing hardware), or a server in a cloud computing system. In some implementations, the dynamic electronic identification association device 430 may include computing hardware used in a cloud computing environment.

The dynamic electronic identification management device 440 may include one or more devices capable of receiving, generating, storing, processing, providing, and/or routing information associated with dynamic electronic identification associated with an electronic card, as described elsewhere herein. The dynamic electronic identification management device 440 may include a communication device and/or a computing device. For example, the dynamic electronic identification management device 440 may include a server, such as an application server, a client server, a web server, a database server, a host server, a proxy server, a virtual server (e.g., executing on computing hardware), or a server in a cloud computing system. In some implementations, the dynamic electronic identification management device 440 may include computing hardware used in a cloud computing environment.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with a dynamic electronic identification associated with an electronic card. The device 500 may correspond to dynamic electronic identification association device 430. In some implementations, dynamic electronic identification association device 430 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

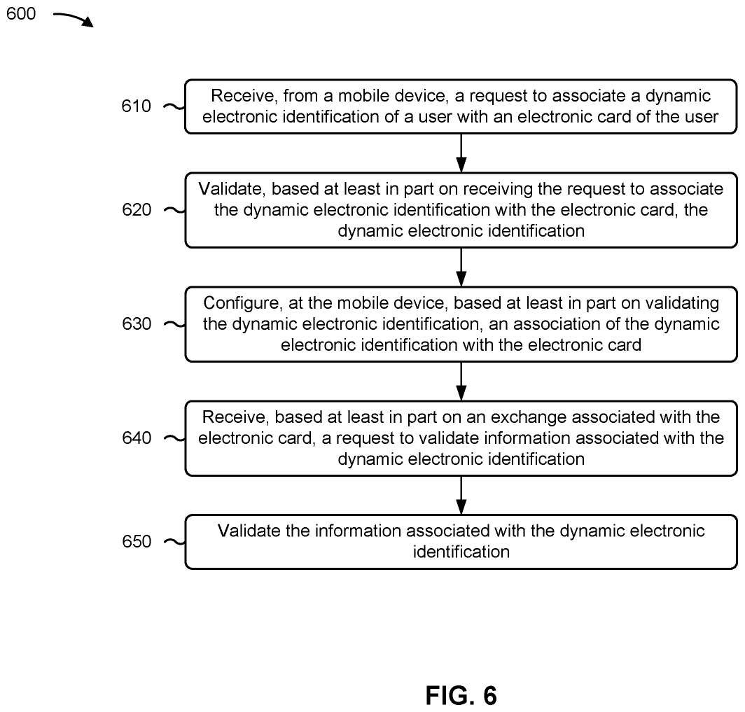

FIG. 6 is a flowchart of an example process 600 associated with a dynamic electronic identification associated with an electronic card. In some implementations, one or more process blocks of FIG. 6 may be performed by the dynamic electronic identification association device 430. In some implementations, one or more process blocks of FIG. 6 may be performed by another device or a group of devices separate from or including the dynamic electronic identification association device 430, such as the mobile device 410, the transaction terminal 420, and/or the dynamic electronic identification management device 440. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving, from a mobile device, a request to associate a dynamic electronic identification of a user with an electronic card of the user (block 610). For example, the dynamic electronic identification association device 430 (e.g., using processor 520, memory 530, input component 540, and/or communication component 560) may receive, from a mobile device, a request to associate a dynamic electronic identification of a user with an electronic card of the user, as described above in connection with reference number 110 of FIG. 1A. As an example, a dynamic electronic identification association device may receive a request to associate an mDL with an electronic card.

As further shown in FIG. 6, process 600 may include validating, based at least in part on receiving the request to associate the dynamic electronic identification with the electronic card, the dynamic electronic identification (block 620). For example, the dynamic electronic identification association device 430 (e.g., using processor 520 and/or memory 530) may validate, based at least in part on receiving the request to associate the dynamic electronic identification with the electronic card, the dynamic electronic identification, as described above in connection with reference number 120 of FIG. 1A. As an example, the dynamic electronic identification association device may validate the mDL using a dynamic electronic identification management device.

As further shown in FIG. 6, process 600 may include configuring, at the mobile device, based at least in part on validating the dynamic electronic identification, an association of the dynamic electronic identification with the electronic card (block 630). For example, the dynamic electronic identification association device 430 (e.g., using processor 520 and/or memory 530) may configure, at the mobile device, based at least in part on validating the dynamic electronic identification, an association of the dynamic electronic identification with the electronic card, as described above in connection with reference number 130 of FIG. 1A. As an example, the dynamic electronic identification association device may configure the mobile device to store, in a digital wallet application, the mDL with the electronic card.

As further shown in FIG. 6, process 600 may include receiving, based at least in part on an exchange associated with the electronic card, a request to validate information associated with the dynamic electronic identification (block 640). For example, the dynamic electronic identification association device 430 (e.g., using processor 520, memory 530, input component 540, and/or communication component 560) may receive, based at least in part on an exchange associated with the electronic card, a request to validate information associated with the dynamic electronic identification, as described above in connection with reference number 140 of FIG. 1B. As an example, the dynamic electronic identification association device may receive a request to validate a user age provided by the dynamic electronic identification.

As further shown in FIG. 6, process 600 may include validating the information associated with the dynamic electronic identification (block 650). For example, the dynamic electronic identification association device 430 (e.g., using processor 520 and/or memory 530) may validate the information associated with the dynamic electronic identification, as described above in connection with reference number 150 of FIG. 1B. As an example, the dynamic electronic identification association device may validate the user age using the dynamic electronic identification management device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A, 1B, 2, and 3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dynamic electronic identification, the system comprising:
one or more memories; and
one or more processors, communicatively coupled to the one or more memories, configured to:
receive, from a mobile device, a request to associate a dynamic electronic identification of a user with an electronic card of the user;
validate, based at least in part on receiving the request to associate the dynamic electronic identification with the electronic card, the dynamic electronic identification;
configure, at the mobile device, based at least in part on validating the dynamic electronic identification, an association of the dynamic electronic identification with the electronic card;
receive, based at least in part on an exchange associated with the electronic card, a request to validate information associated with the dynamic electronic identification; and
validate the information associated with the dynamic electronic identification.

2. The system of claim 1, wherein the dynamic electronic identification is configured for dynamic updates.

3. The system of claim 1, wherein the one or more processors, to validate the dynamic electronic identification, are configured to:
provide, to a dynamic electronic identification management device, a request to validate the dynamic electronic identification; and
receive, from the dynamic electronic identification management device, a validation of the dynamic electronic identification.

4. The system of claim 1, wherein the electronic card and the dynamic electronic identification are associated with a mobile application of the mobile device.

5. The system of claim 1, wherein the one or more processors, to validate the information associated with the dynamic electronic identification, are configured to:
provide, to a dynamic electronic identification management device, a request to validate the information associated with the dynamic electronic identification; and
receive, from the dynamic electronic identification management device, a validation of the information associated with the dynamic electronic identification.

6. The system of claim 1, wherein the one or more processors are further configured to:
process, based at least in part on validating the information associated with the dynamic electronic identification, the exchange.

7. The system of claim 6, wherein the exchange is an age-restricted exchange, and wherein the information associated with the dynamic electronic identification includes an age of the user.

8. The system of claim 6, wherein the one or more processors are further configured to:
provide an indication that the exchange has been processed.

9. The system of claim 1, wherein the exchange is associated with an event, and wherein the information associated with the dynamic electronic identification is associated with user access to the event.

10. A method for dynamic electronic identification, comprising:
receiving, by a device, from a mobile device, a request to associate a dynamic electronic identification of a user with an electronic card of the user;
validating, by the device, based at least in part on receiving the request to associate the dynamic electronic identification with the electronic card, the dynamic electronic identification; and
configuring, by the device, at the mobile device, based at least in part on validating the dynamic electronic identification, an association of the dynamic electronic identification with the electronic card.

11. The method of claim 10, wherein the dynamic electronic identification is configured for dynamic updates.

12. The method of claim 10, wherein the electronic card and the dynamic electronic identification are associated with a mobile application.

13. A non-transitory computer-readable medium storing a set of instructions, the set of instructions comprising:
one or more instructions that, when executed by one or more processors of a system for dynamic electronic identification, cause the system for dynamic electronic identification to:
receive, based at least in part on an exchange associated with an electronic card of a user, a request to validate information associated with a dynamic electronic identification associated with the electronic card of the user; and
validate the information associated with the dynamic electronic identification.

14. The non-transitory computer-readable medium of claim 13, wherein the dynamic electronic identification is configured for dynamic updates.

15. The non-transitory computer-readable medium of claim 13, wherein the one or more instructions, that cause the system for dynamic electronic identification to validate the information associated with the dynamic electronic identification, cause the system for dynamic electronic identification to:
provide, to a dynamic electronic identification management device, a request to validate the information associated with the dynamic electronic identification; and
receive, from the dynamic electronic identification management device, a validation of the information associated with the dynamic electronic identification.

16. The non-transitory computer-readable medium of claim 13, wherein the electronic card and the dynamic electronic identification are associated with a mobile application.

17. The non-transitory computer-readable medium of claim 13, wherein the one or more instructions further cause the system for dynamic electronic identification to:
process, based at least in part on validating the information associated with the dynamic electronic identification, the exchange.

18. The non-transitory computer-readable medium of claim 17, wherein the exchange is an age-restricted exchange, and wherein the information associated with the dynamic electronic identification includes an age of the user.

19. The non-transitory computer-readable medium of claim 17, wherein the one or more instructions further cause the system for dynamic electronic identification to:
provide an indication that the exchange has been processed.

20. The non-transitory computer-readable medium of claim 13, wherein the exchange is associated with an event, and wherein the information associated with the dynamic electronic identification is associated with user access to the event.
